(19) United States
(12) Patent Application Publication
(10) Pub. No.: US 2021/0235611 A1
(43) Pub. Date: Aug. 5, 2021

(54) Row Unit Arm Sensor And Associated Systems And Methods

(71) Applicant: Ag Leader Technology, Ames, IA (US)

(72) Inventor: Adam Fett, Nevada, IA (US)

(21) Appl. No.: 17/164,213

(22) Filed: Feb. 1, 2021

Related U.S. Application Data
(60) Provisional application No. 62/967,735, filed on Jan. 30, 2020.

(51) Int. Cl. A01C 7/20; A01B 79/00

(52) U.S. Cl. CPC A01C 7/203; A01B 79/005

(57) ABSTRACT

The disclosure relates to agricultural planter and associated devices and systems. In various implementations, the planter includes a toolbar and at least one row unit. Each row unit may include at least one parallel bar and a sensor fixedly attached to the toolbar and rotatably fixed to the at least one parallel bar. The sensor is configured to measure the movement of the at least one row unit relative to the toolbar. This detected movement of the row unit is indicative of row unit position that may be used by a monitoring system to evaluate various parameters and situations during high speed planting.

### CROSS-REFERENCE TO RELATED APPLICATIONS

This application claims the benefit of U.S. Provisional Application 62/967,735, filed Jan. 30, 2020, and entitled “Row Unit Parallel Arm Sensor and Associated Systems and Methods,” under 35 U.S.C. § 119(e), which is hereby incorporated herein by reference in its entirety for all purposes.

### TECHNICAL FIELD

The disclosure relates to agricultural planters and associated systems and devices. Various implementations relate to devices, systems, and methods for use in high-speed agriculture.

### BACKGROUND

Agricultural planters typically include a plurality of row units. Agricultural planters and their row units come in a variety of configurations and include a variety of different systems and devices. During high speed planting optimal performance of the planter and its associated row units and other systems and devices may impact the efficiency and quality of planting thereby effecting overall yield.

### BRIEF SUMMARY

Disclosed herein are various devices, systems and methods for monitoring and evaluating the performance of planting equipment in real-time. The disclosed devices, systems, and methods allow for providing real-time feedback to farmers and other stakeholders during planting. For example, the system may provide information on how certain equipment such as a row unit and/or supplemental downforce system is performing during planting. Additionally, the disclosed devices, systems, and methods can indicate performance problems in real time.

In Example 1, a planter monitoring system comprising a toolbar, one or more row units, each row unit attached to the toolbar via one or more linkages, a sensor mounted on the toolbar and attached to the one or more linkages via an arm, and a row control module in communication with the sensor, wherein the row control module is configured to evaluate signals from the sensor to determine ride quality of the one or more row units.

In Example 2, the system of Example 1, wherein the arm includes a first arm section extending from the sensor substantially parallel with the one or more linkages and a second arm section extending from the first arm section the second arm section substantially perpendicular to the first arm section.

In Example 3, the system of Example 1, wherein the sensor is a voltage sensor.

In Example 4, the system of Example 1, wherein stable signal from the sensor indicates a high ride quality and wherein an unstable signal from the sensor indicates a low ride quality.

In Example 5, the system of Example 1, further comprising a display in communication with the row control module, wherein the display presents ride quality information to a user.

In Example 6, the system of Example 1, further comprising a supplemental downforce system, wherein a high ride quality indicates the supplemental downforce system is operating optimally and wherein a low ride quality indicates the supplemental downforce system is operating sub-optimally.

In Example 7, the system of Example 1, wherein the sensor signal varies with vertical movement of the one or more row units as a planter traverses a field.

In Example 8, the system of Example 1, further comprising a set position for triggering the one or more row units to turn off or on, wherein the set position is a particular signal from the sensor such that when the particular signal is sent the one or more row units turn off or on.

In Example 9, the system of Example 8, wherein the set position is a particular voltage indicative of a certain position of the one or more row units relative to the toolbar or terrain.

In Example 10, a planter comprising a toolbar, at least one row unit, each row unit engaged with the toolbar via a parallel linkage, a sensor fixedly attached to the toolbar and further engaged with the parallel linkage via an arm, and a processor in communication with the sensor for receiving sensor signals, wherein the sensor signals indicate a position of the at least one row unit relative to the toolbar.

In Example 11, the planter of Example 10, wherein the arm comprises a first section wherein the first section is attached to the sensor and is substantially parallel to the parallel linkage and a second section wherein the second section is attached to first section and the parallel linkage.

In Example 12, the planter of Example 10, wherein the sensor is a voltage sensor or a potentiometer.

In Example 13, the planter of Example 10, wherein the processor processes the sensor signals to provide a user with data about one or more of row unit ride quality, soil hardness, and supplemental downforce system function.

In Example 14, the planter of Example 13, further comprising an alarm, wherein the alarm is activated when row unit ride quality is below a predetermined threshold.

In Example 15, the planter of Example 10, further comprising a storage medium in communication with the processor, wherein the storage medium is configured to record sensor signals over time, and wherein analysis of sensor signals over time is an indicator of row unit ride quality.

In Example 16, the planter of Example 10, further comprising a set point, wherein the set point is a sensor signal, and wherein when the set point is exceeded the at least one row unit is triggered off.

In Example 17, the planter of Example 16, wherein the set point is set at a row unit position that is lower than row unit lift stops.

In Example 18, a planter row unit position sensor comprising a position sensor, an arm extending from the position sensor, the arm comprising a first arm section having a first end and a second end, the first end of the first arm section operatively engaged with the position sensor and a second arm section having a first end and a second end, the first end of the second arm section engaged with the second end of the first arm section and the second end of the second arm section operatively engaged with a row unit, wherein the arm moves vertically along with a row unit and wherein the position sensor senses vertical movement of the arm and records such vertical movement.

In Example 19, the sensor of Example 18, wherein the sensor is a potentiometer sensor.

In Example 20, the sensor of Example 18, wherein the sensor is a voltage sensor.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a planter, according to one implementation.

FIG. 2A is a side view of a row unit, according to one implementation.

FIG. 2B is a schematic view of the system, according to one implementation.

FIG. 3A is a side view of a row unit, according to one implementation.

FIG. 3B is a chart depicting sensor output over time.

FIG. 4A is a side view of a row unit, according to one implementation.

FIG. 4B is a chart depicting sensor output over time.

FIG. 5A is a side view of a row unit, according to one implementation.

FIG. 5B is a chart depicting sensor output over time.

FIG. 6A is a side view of a row unit, according to one implementation.

FIG. 6B is a side view of a row unit, according to one implementation.

FIG. 7 is a flow chart showing operation of the system, according to one implementation.

### DETAILED DESCRIPTION

The various implementations disclosed and contemplated herein relate to agricultural planting, more particularly to devices, systems, and methods for use in high-speed planting. The disclosed system allows users to monitor ride quality and the position of individual row units while traversing a field. Further, in some implementations, the system provides a user with knowledge of the performance of an associated row unit downforce system.

The monitoring system may utilize sensor data to determine the position of a row unit to indicate how the row unit is traveling up and down relative to the ground and/or toolbar as the planter and row unit are being pulled through a field. In various implementations, the disclosed sensors allow for reporting information to users about row unit position, ride quality, and/or planting depth.

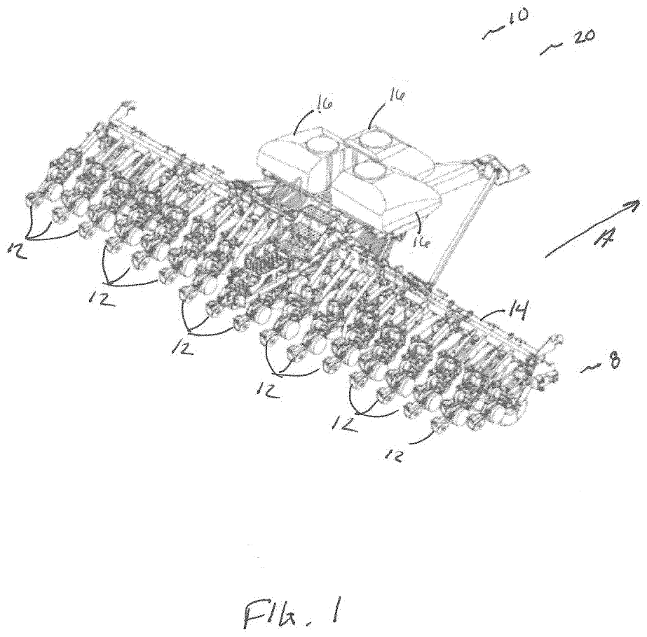

The devices, systems, and methods disclosed herein may be used in connection with various known planters and row units. FIG. 1 depicts one exemplary planter 10 fitted with an exemplary implementation of the disclosed system 20. Such implementations of the system 20 are adapted to operate with such a planter 10 including a plurality of row units 12 constructed and arranged for planting row crops such as corn, optionally at high speed.

The planting machine 10 in this specific implementation is a row crop planter 10 having a central crossbar 14 and multiple planting row units 12 mounted to the crossbar 14. It is understood that, generally, the row units 12 on a particular planter (such as exemplary planter 10) are typically identical or substantially similar. The planter 10 moves forward and backward via the fore-aft direction shown by the arrow A.

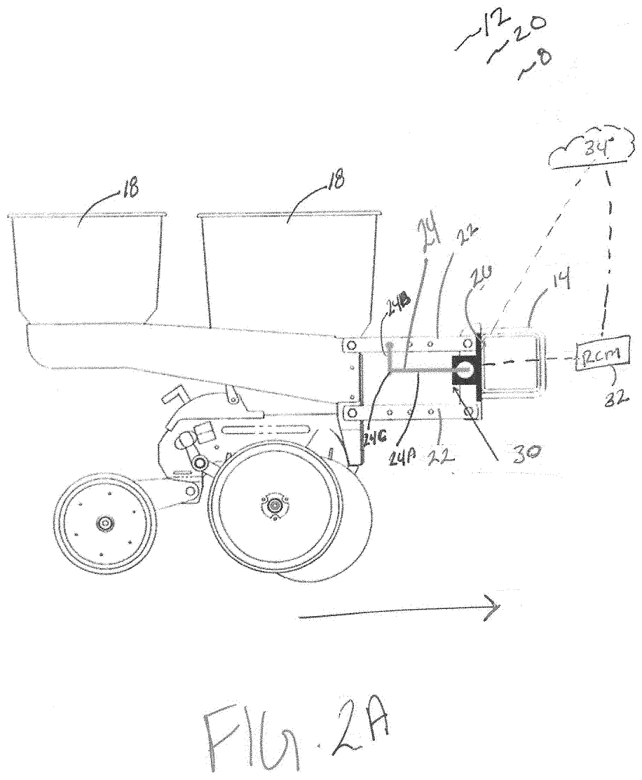

In various implementations, the planter 10 includes at least one hopper 16 to hold seed or other optional compositions to be deposited during planting operations. In certain implementations, the planter 12 includes unit hoppers (such as hopper 18 shown in FIG. 2) on each planting unit 14 such that seed or other compositions can be delivered from the hopper 16 to a unit hopper on each row unit 12. In a further alternative implementation, any known hopper or seed retention device configuration can be incorporated into the planter 10 and the separate row units 12 and function with a monitoring system 20 implementation, as described herein.

In some implementations, the row 12 unit includes a supplemental downforce system 8, such as a hydraulic, pneumatic, mechanical spring, or other system as would be appreciated by those of skill in the art. The supplemental downforce system 8 applies downforce to the row units 12 to maintain proper planting depth. In certain implementations, the supplemental downforce system 8 applies additional force to penetrate hard soils and applies uplift or less downforce in soft soils. Various other functions and purposes for a supplemental downforce or airbag system 8 would be known to those of skill in the art.

Certain of the disclosed implementations of the monitoring system 20, and associated devices and methods can be used in conjunction with any of the devices, systems, or methods taught or otherwise disclosed in U.S. application Ser. No. 16/121,065, filed Sep. 1, 2018, and entitled “Planter Down Pressure and Uplift Devices, Systems, and Associated Methods,” U.S. Pat. No. 10,743,460, filed Oct. 3, 2018, and entitled “Controlled Air Pulse Metering Apparatus for an Agricultural Planter and Related Systems and Methods,” U.S. application Ser. No. 16/272,590, filed Feb. 11, 2019, and entitled “Seed Spacing Device for an Agricultural Planter and Related Systems and Methods,” U.S. application Ser. No. 16/142,522, filed Sep. 26, 2018, and entitled “Planter Downforce and Uplift Monitoring and Control Feedback Devices, Systems and Associated Methods,” U.S. application Ser. No. 16/280,572, filed Feb. 20, 2019 and entitled “Apparatus, Systems and Methods for Applying Fluid,” U.S. application Ser. No. 16/371,815, filed Apr. 1, 2019, and entitled “Devices, Systems, and Methods for Seed Trench Protection,” U.S. application Ser. No. 16/523,343, filed Jul. 26, 2019, and entitled “Closing Wheel Downforce Adjustment Devices, Systems, and Methods,” U.S. application Ser. No. 16/670,692, filed Oct. 31, 2019, and entitled “Soil Sensing Control Devices, Systems, and Associated Methods,” U.S. application Ser. No. 16/684,877, filed Nov. 15, 2019, and entitled “On-The-Go Organic Matter Sensor and Associated Systems and Methods,” U.S. application Ser. No. 16/752,989, filed Jan. 27, 2020, and entitled “Dual Seed Meter and Related Systems and Methods,” U.S. application Ser. No. 16/891,812, filed Jun. 3, 2020, and entitled “Apparatus, Systems, and Methods for Row Cleaner Depth Adjustment On-The-Go,” U.S. application Ser. No. 16/921,828, filed Jul. 6, 2020, and entitled “Apparatus, Systems and Methods for Automatic Steering Guidance and Visualization of Guidance Paths,” U.S. application Ser. No. 16/939,785, filed Jul. 27, 2020, and entitled “Apparatus, Systems and Methods for Automated Navigation of Agricultural Equipment,” U.S. application Ser. No. 16/997,361, filed Aug. 19, 2020, and entitled “Apparatus, Systems, and Methods for Steerable Toolbars,” U.S. application Ser. No. 16/997,040, filed Aug. 19, 2020, and entitled “Adjustable Seed Meter and Related Systems and Methods,” U.S. application Ser. No. 17/011,737, filed Aug. 3, 2020, and entitled “Planter Row Unit and Associated Systems and Methods,” U.S. application Ser. No. 17/060,844, filed Oct. 1, 2020, and entitled “Agricultural Vacuum and Electrical Generator Devices, Systems, and Methods,” U.S. application Ser. No. 17/105,437, filed Nov. 25, 2020, and entitled “Devices, Systems And Methods For Seed Trench Monitoring And Closing,” U.S. application Ser. No. 17/127,812, filed Dec. 18, 2020, and entitled “Seed Meter Controller and Associated Devices, Systems, and Methods,” and U.S. application Ser. No. 17/132,152, filed Dec. 23, 2020, and entitled “Use of Aerial Imagery For Vehicle Path Guidance And Associated Devices, Systems, And Methods,” each of which is incorporated herein.

Turning back to the figures, FIG. 2A shows a side view of a row unit 12 with an attached sensor 30. In various implementations, the sensor 30 is operatively engaged with the planter tool bar 14 and parallel bars 22. The sensor 30 may be mounted on the tool bar 14 via a bracket 26 or any other attachment mechanism as would be appreciated by those of skill in the art. In some implementations, the sensor 30 is affixed to at least one of the parallel linkages 22 via an arm 24 (also referred to as a bar 24).

In certain implementations, the arm 24 includes a first section 24A extending rearwardly from the sensor 30, relative to the direction of travel (shown at reference arrow A). In various implementations, the first section 24A is substantially parallel to one or more of the parallel linkages 22. The arm 24 may further include a second section 24B connecting the first section 24A to the parallel linkages 22. In various implementations, the second section 24B is substantially perpendicular to the first section 24A and the parallel linkages 22. In various implementations, the first section 24A and second section 24B are integral, or in alternative implementations, the first section 24A and second section 24B are joined at a joint 24C. In various implementations, the joint 24C is a rotational or hinge joint allowing for the flexible movement of the first section 24A and the second section 24B relative to each other. In implementations with a movable joint 24C, the moveable joint 24C may reduce stress on the arm 24.

In various implementations, the system 20 and sensor 30 may be used to calibrate the row unit 12 and associated systems, such as a supplemental downforce system 8 and other planting system. In further implementations, the system 20 may allow for configuring various alarms and/or alerts for use in conjunction with row-by-row planting systems, as will be discussed further below. In various of these implementations, the alarms and/or alerts are based on the detected position of the row unit 12.

Turning to FIG. 2B, in various implementations, the sensor 30 is configured to send various data, such as voltage or other position information, to a row control module (RCM) 32 and/or another centralized system 34. In various implementations, the sensor 30 is an encoder or other position sensor configured to detect the rotational movement of the arm 24 as the row unit 12 traverses a field or other terrain.

In certain implementations, the centralized system 34 may be remote from the physical planter 10. For example, the centralized system 34 may be cloud 36 based. In various alternative implementations, the centralized system 34 is disposed on a display 38 associated with a tractor 4 or other agricultural vehicle 4 that is configured to tow the planting implement 10. In some implementations, the sensor 30 is in communication with a display 38 or other monitor, such as an in-cab display 38.

In further implementations, the voltage/position data stored and/or further processed by the centralized system 34 on the cloud 36, on the display 38, and/or on any other appropriate device as would be understood and as will be discussed further below. In various implementations, a storage device 40 is in communication with the centralized system 34 and/or RCM 32 for storage of the data collected by the sensor 30. The storage device 40 may be in communication with the centralized system 34 via any known wired or wireless connection. In certain implementations, the storage device 40 is a database 40 that is in wireless communication with the cloud 36 for storage of the various data. Various alternative implementations are of course possible.

Continuing with FIGS. 2A and 2B, in some implementations, the sensor 30 is an analog voltage sensor. In alternative implementations, the sensor 30 may be a potentiometer. Voltage information from the sensor 30 can be used to determine ride quality. In these implementations, the voltage signal correlates to ride quality, where the more erratic or varied the signal the poorer the ride quality. Conversely, the more stable or static the voltage signal the better the ride quality.

In various implementations, ride quality may in turn correlate to operation of a supplemental downforce system 8. In some implementations, a more stable voltage signal or high ride quality may indicate that the supplemental downforce system 8 is working as expected. As would be understood, a supplemental downforce system 8 operates to maintain proper planting depth so that the planter 10 and the individual row units 12 are operating efficiently and yields are maximized. An erratic/varied voltage signal or low ride quality may indicate that the supplemental downforce system 8 is not operating correctly and therefore the planter 10 and/or row unit 12 may not be operating optimally. That is, low ride quality can be correlated with the suboptimal performance of a row unit 12, which may in turn lead to decreased yield at harvest, as would be appreciated.

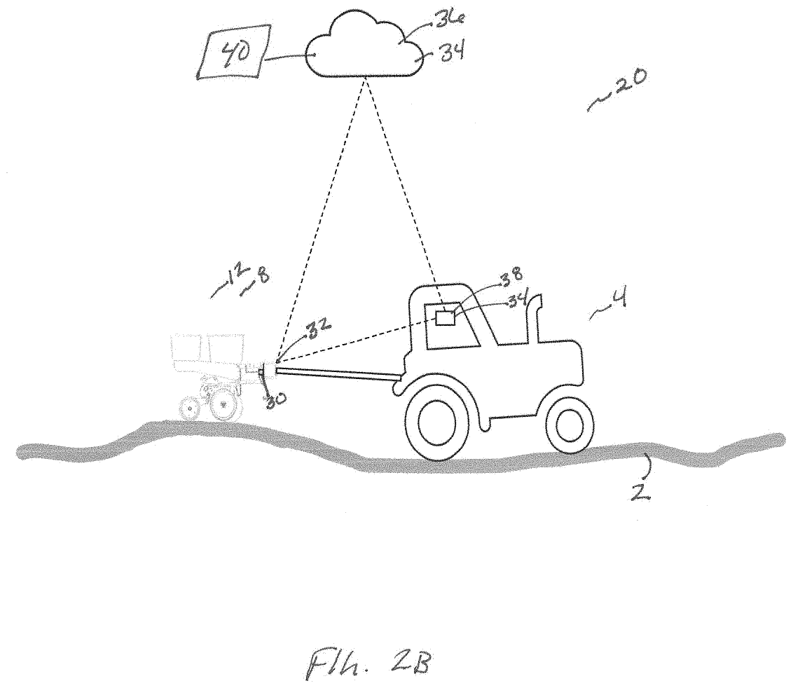

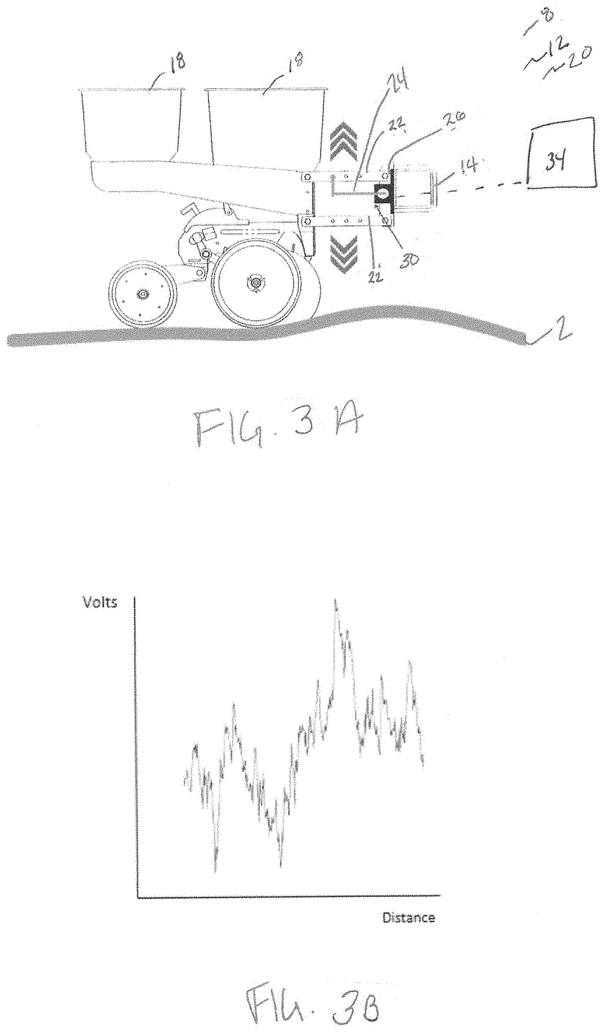

Turning to FIGS. 3A and 3B, FIG. 3A shows a row unit 12 including the system 20 and sensor 30 riding over uneven terrain 2. FIG. 2B shows an exemplary voltage signal for the row unit 12 as it traverses the terrain 2. As can be observed, the uneven/rough terrain 2 may cause the row unit 12 to ride more erratically, particularly if the supplemental downforce system 8 or air bag system is not working properly. In various implementations, the sensor 30 sends a voltage signal to the RCM 32 or centralized monitor 34 where the system 20 can inform a user of the erratic signal, such that corrective action can be taken.

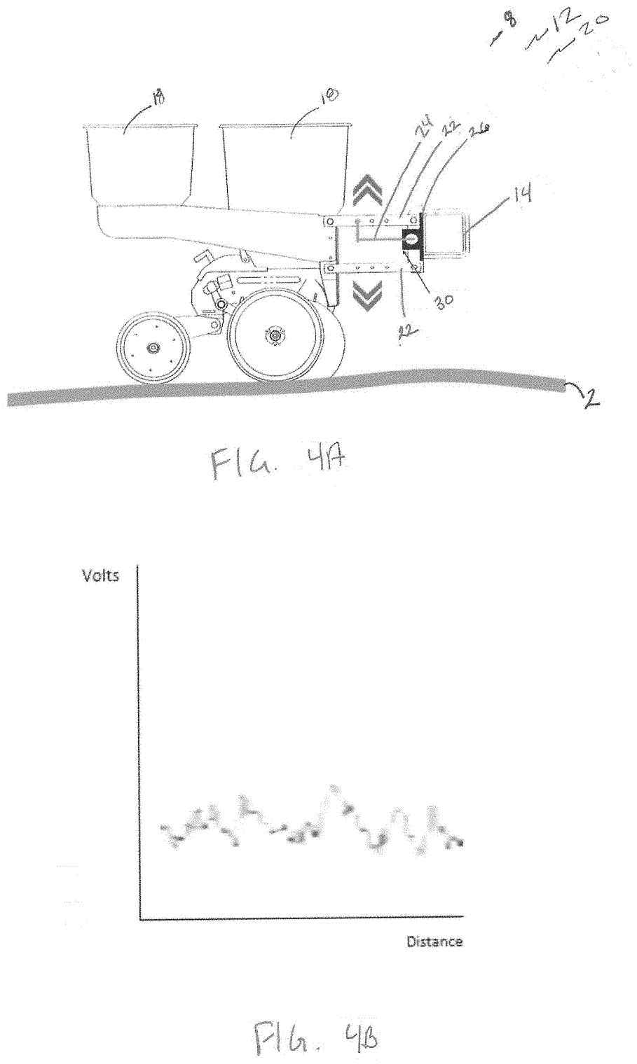

In another exemplary implementation, FIG. 4A shows a row unit 12 traversing terrain 2 and FIG. 3B shows corresponding voltage signals. In some implementations, where the terrain 2 is less rough the voltage signal is more constant. Alternatively, a more constant voltage signal, such as that shown in FIG. 3B can be due to the proper functioning of a supplemental downforce 8 or air bag system.

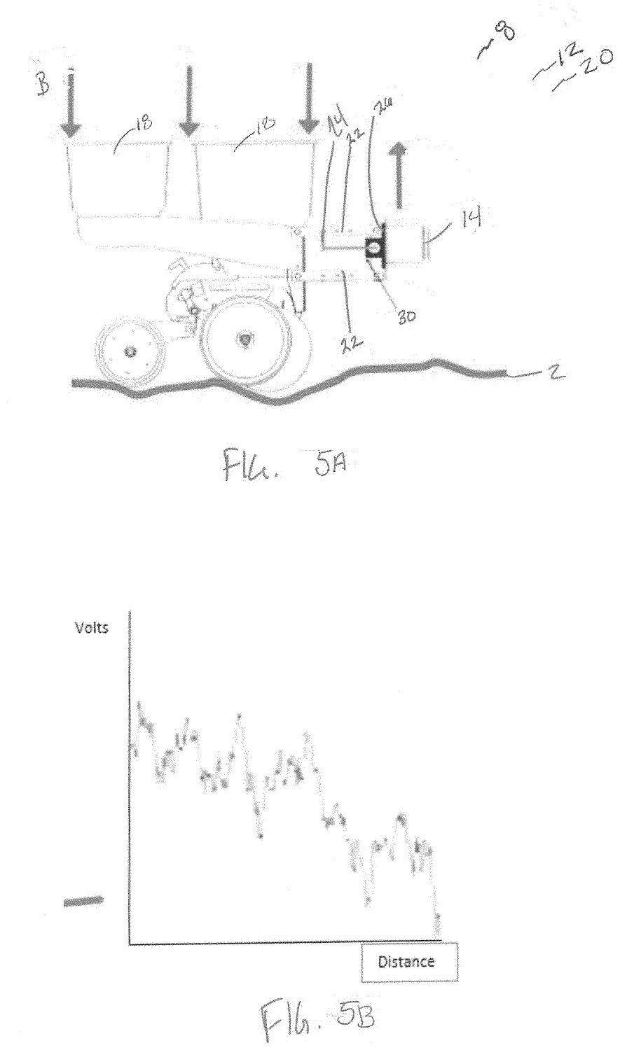

In further implementations, the sensors 30 may be used as an indicator of soil hardness. As shown in FIGS. 5A and 5B, the system 20 may show if the row unit 12 is being lifted out of the ground due to hard soils. FIG. 5A depicts an exemplary implementation of the system 20 where the supplemental downforce system 8 is applying additional downforce—pushing the row unit 12 down towards the terrain 2, shown at reference arrow B. If the soil is harder than anticipated, or insufficient downforce is being applied to the row unit 12, which in turn may bounce vertically or otherwise be pushed away from the terrain 2 as would be readily understood. This vertical movement of the row unit 12 can then be detected by the sensor 30. In response, the system 20 can be configured to send a corresponding signal to the centralized system 34 and/or a display 38 for storage, processing, and/or communication to a user. In certain implementations, the user is then able to make adjustments to the downforce system 8 or other associated system to ensure planting efficiency, as appropriate.

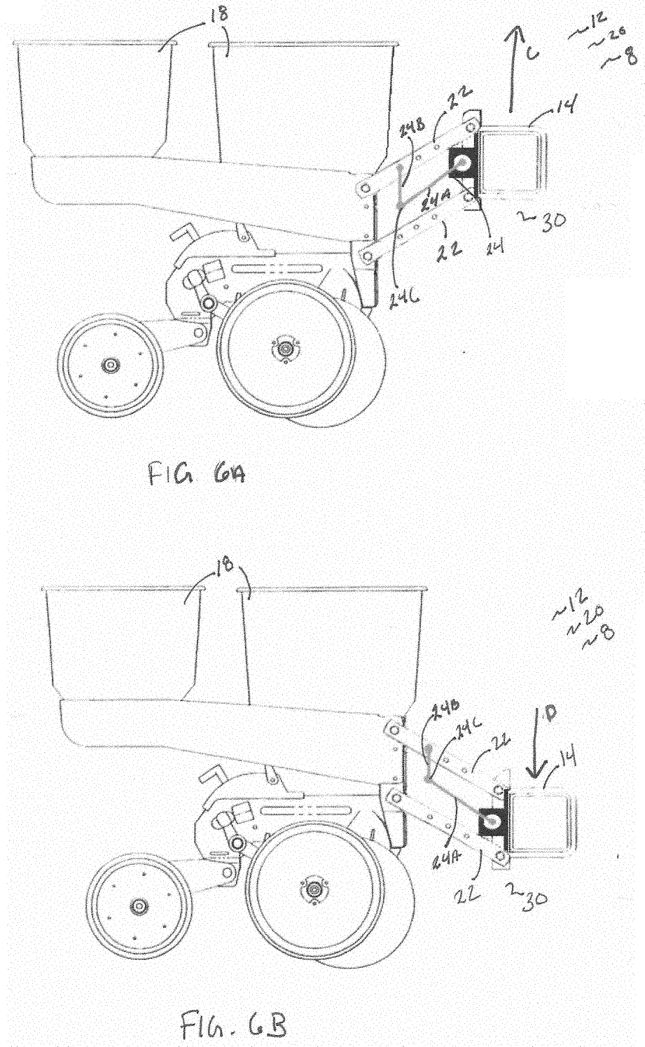

In further implementations, the sensor 30 and system 20 may be utilized to improve row unit lifting and lowering times. As is understood, a planter 10 must be lifted and lowered when turning equipment in a field between passes. FIG. 6A shows an exemplary row unit 12 in a fully lifted position. In the lifted position the toolbar 14 is raised, along reference arrow C, such that the row unit 12 “hangs” from the toolbar 14. FIG. 6B shows an exemplary row unit 12 in a fully lowered position. In the lowered position, the toolbar 14 is lowered towards the ground, along reference arrow D such that the row unit 12 engages the ground. In various implementations, the system 20 may calibrate a set position for sensor 30 output, such that when the set position is reached the row unit 12 may be triggered to turn off or on. The set position may be a set voltage that indicates when the row units 12 are hanging off the toolbar 14 but before the planter 10 is raised to its lift stops, as would be understood. By eliminating the need to raise the toolbar 12 to its lift stops while turning the equipment planting efficiency can be increased. That is, the toolbar 14 and row units 12 need only be partially lifted to ensure ground clearance thereby increasing the speed at which a pass can be ended, and new row begun.

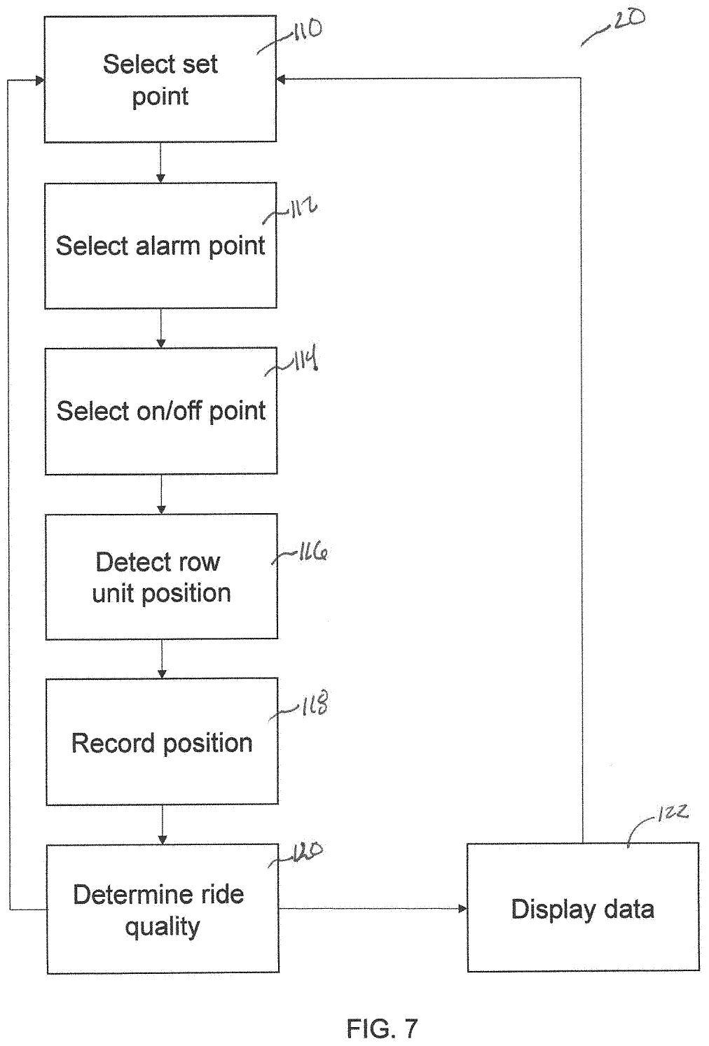

FIG. 7 depicts an exemplary implementation of the system 20 implementing a series of optional steps. In various implementations, each step is optional and may be performed in any order or not at all. In the implementation of FIG. 7, the monitoring system 20 is configured to detect and read the signals generated by the sensor(s) 30. In some implementations, the monitoring system 20 may be integrated into an existing planter display system, such as a software-integrated display platform, for example InCommand® or others known in the art.

In various implementations, the monitoring system 20 includes one or more computers that can be configured to perform particular operations or actions by virtue of having software, firmware, hardware, or a combination of them installed on the system that in operation causes or cause the system to perform the actions. Further, one or more computer programs can be configured to perform particular operations or actions by virtue of including instructions that, when executed by a data processing apparatus, cause the apparatus to perform the actions.

In various implementations, the monitoring system 20 includes a display (shown for example at 38 in FIG. 2B) and/or a storage medium such as a database or storage drive (shown for example at 40 in FIG. 2B) to store and log the sensor 30 signals. The monitoring system 20 may also include a processor or other hardware capable of processing and reporting sensor signals 30 to users. In various implementations this processing is local to the planter 8 and for example may be executed by the RCM 34. In certain alternative implementations, the processing is executed in the cloud 36 or the remote system and/or at the display 38.

In further implementations, the monitoring system 20 includes a display 38 to present the processed and/or raw sensor 30 signals to a user. The data from processed signals may include a ride quality score, information regarding soil hardness, status of the supplemental downforce system 8, and/or any other information as would be recognized in light of this disclosure.

In some implementations, the monitoring system 20 disclosed herein, and shown in FIG. 7, allows a user to calibrate and implement one or more optional switches on a row unit using the sensor 30. The calibration may include setting one or more set point(s) (boxes 110, 112 & 114). In various implementations, an optional set point can be set for a neutral position of the planter row units (box 110). Additional set points may also optionally include a set point for various alarms and/or alerts (box 112) or an optional set point for toggling the functionality of the row unit 12/planter 10 on and off (box 114).

In various implementations, in one optional step, the monitoring system 20 operates by detecting the row unit 12 position via the sensor 30 signals (box 116) and then in another optional step storing/logging the position (box 118). In a further optional step, the detected position may be compared to the various set points (box 110, 112, 114). For example, when the monitoring system 20 detects that the row unit 12 is at the set point for turning the unit 12 off, the monitoring system 20 may automatically turn off the functionality of the row unit 12. In another example, when the monitoring system 20 detects that the row unit 12 has exceeded an alarm point as set (box 112) the system 20 emits an alarm.

In various implementations, the neutral set point (box 110) may optionally be compared to the sensor signal 30 and used by the system 20 to indicate the position of the row unit 12 relative to the toolbar 14 and/or terrain 2. As discussed above, the position of the row unit 12 can optionally be used to determine ride quality (box 120), or vertical movement of the row unit 12 over time. The monitoring system 20 may then optionally display the ride quality and/or other data to a user (box 122).

In further implementations, in an optional step, the monitoring system 20 may detect if a row unit 12 is being lifted out of the soil by the supplemental downforce system 8 due to hard soils. This data may optionally be displayed to a user (box 122). In further implementations, the monitoring system 20 may optionally be configured with a set point or other indication to alert a user if one or more row units 12 are not planting at the proper depth—too shallow or too deep as determined by a position threshold. Additional set points and subsequent actions are possible and contemplated herein.

Although the disclosure has been described with references to various embodiments, persons skilled in the art will recognized that changes may be made in form and detail without departing from the spirit and scope of this disclosure.

What is claimed is:

1. A planter monitoring system comprising:
(a) a toolbar;
(b) one or more row units, each row unit attached to the toolbar via one or more linkages;
(c) a sensor mounted on the toolbar and attached to the one or more linkages via an arm; and
(d) a row control module in communication with the sensor,
wherein the row control module is configured to evaluate signals from the sensor to determine ride quality of the one or more row units.

2. The system of claim 1, wherein the arm includes a first arm section extending from the sensor substantially parallel with the one or more linkages and a second arm section extending from the first arm section the second arm section substantially perpendicular to the first arm section.

3. The system of claim 1, wherein the sensor is a voltage sensor.

4. The system of claim 1, wherein stable signal from the sensor indicates a high ride quality and wherein an unstable signal from the sensor indicates a low ride quality.

5. The system of claim 1, further comprising a display in communication with the row control module, wherein the display presents ride quality information to a user.

6. The system of claim 1, further comprising a supplemental downforce system, wherein a high ride quality indicates the supplemental downforce system is operating optimally and wherein a low ride quality indicated the supplemental downforce system is operating sub-optimally.

7. The system of claim 1, wherein the sensor signal varies with vertical movement of the one or more row units as a planter traverses a field.

8. The system of claim 1, further comprising a set position for triggering the one or more row units to turn off or on, wherein the set position is a particular signal from the sensor such that when the particular signal is sent the one or more row units turn off or on.

9. The system of claim 8, wherein the set position is a particular voltage indicative of a certain position of the one or more row units relative to the toolbar or terrain.

10. A planter comprising:
(a) a toolbar;
(b) at least one row unit, each row unit engaged with the toolbar via a parallel linkage;
(c) a sensor fixedly attached to the toolbar and further engaged with the parallel linkage via an arm; and
(d) a processor in communication with the sensor for receiving sensor signals,
wherein the sensor signals indicate the positions of the at least one row unit relative to the toolbar.

11. The planter of claim 10, wherein the arm comprises a first section wherein the first section is attached to the sensor and is substantially parallel to the parallel linkage and a second section wherein the second section is attached to first section and the parallel linkage.

12. The planter of claim 10, wherein the sensor is a voltage sensor or a potentiometer.

13. The planter of claim 10, wherein the processor processes the sensor signals to provide a user with data about one or more of row unit ride quality, soil hardness, and supplemental downforce system function.

14. The planter of claim 13, further comprising an alarm, wherein the alarm is turned on when the row unit ride quality is below a predetermined threshold.

15. The planter of claim 10, further comprising a storage medium in communication with the processor, wherein the storage medium is configured to record sensor signals over time, and wherein analysis of sensor signals over time is an indicator of row unit ride quality.

16. The planter of claim 10, further comprising a set point, wherein the set point is a sensor signal, and wherein when the set point is exceeded the at least one row unit is turned off.

17. The planter of claim 16, wherein the set point is set at a row unit position that is lower than row unit lift stops.

18. A planter row unit position sensor comprising:
(a) a position sensor; and
(b) an arm extending from the position sensor, the arm comprising:
(i) a first arm section having a first end and a second end, the first end of the first arm section operatively engaged with the position sensor and
(ii) a second arm section having a first end and a second end, the first end of the second arm section engaged with the second end of the first arm section and the second end of the second arm section operatively engaged with a row unit,
wherein the arm moves vertically along with a row unit and wherein the position sensor senses vertical movement of the arm and records such vertical movement.

19. The sensor of claim 18, wherein the sensor is a potentiometer sensor.

20. The sensor of claim 18, wherein the sensor is a voltage sensor.
